(19) United States
(12) Patent Application Publication
(10) Pub. No.: US 2002/0043853 A1
(43) Pub. Date: Apr. 18, 2002

(54) Pivot mechanism

(76) Inventor: Philip Charles Shephard, Coventry (GB)

Correspondence Address: MERCHANT & GOULD PC, P.O. BOX 2903, MINNEAPOLIS, MN, 55402-0903, US

(21) Appl. No.: 09/794,637

(22) Filed: Feb. 27, 2001

Related U.S. Application Data
(60) Provisional application No. 60/242,053, filed on Oct. 20, 2000.

(30) Foreign Application Priority Data
Oct. 12, 2000 (GB) 0025020.9
Jan. 15, 2001 (GB) 0101007.39

(51) Int. Cl. B60N 2/02; B60N 2/48

(52) U.S. Cl. 297/367

(57) ABSTRACT

A pivot mechanism, in particular for use in a recliner mechanism for a vehicle seat, includes a pivot arm (14) for attachment to the seat back (or “squab”), a base portion (4) for attachment to the seat base, and a locking member (38) mounted on the base portion for movement relative thereto. The locking member (38) and the pivot am (14) have mutually engageable locking formations (36, 40). When the locking formations (36, 40) are engaged, movement of the pivot arm relative to the base portion is prevented.

The present invention relates to a pivot mechanism and in particular but not exclusively to a pivot mechanism for a seat recliner mechanism, for use in cars and other land, sea or air vehicles It is conceivable that the mechanism could also be used in industrial applications, for example where angle adjusters are required.

Recliner mechanisms are provided in vehicle seats to allow the angle of the seat back (or “squab”) to be adjusted relative to the seat base. The mechanism allows the squab to be reclined backwards or forwards for comfort and to allow the driver to operate the vehicle controls comfortably. Sometimes, the squab can also be tipped forwards, for example to provide access to the rear seats or, in the case of the rear seats, to extend the luggage floor.

A seat recliner mechanism has to meet a number of requirements for safe and practical operation. For example, the mechanism must be reliable in operation, strong enough to prevent the squab collapsing in normal use or in the case of a collision, compact, simple to operate, reliable and relatively inexpensive. Meeting all of these criteria is a difficult task.

Many known recliner mechanisms are expensive to produce, for example including many machined parts, and are complicated in design and operation. They are also frequently relatively large, occupying valuable passenger space and possibly affecting passenger comfort and safety. Such mechanisms may also suffer from free play (“chuck”), judder and rattle, which are serious quality issues

It is an object of the present invention to provide a recliner mechanism that mitigates at least some of the aforementioned problems.

According to the present invention there is provided a pivot mechanism, the mechanism including a pivot arm, a base portion and a locking member mounted on the base portion for movement relative thereto, said locking member and said pivot arm having mutually engageable locking formations, the mechanism being constructed and arranged such that when the locking formations are engaged, movement of the pivot arm relative to the base portion is prevented.

The mechanism has only a few moving parts and is relatively simple to operate and inexpensive to manufacture, It is also very strong and reliable. The base portion may be attached in use to a seat base with the pivot arm attached to the squab, or alternatively the base portion may be attached to the squab with the pivot arm attached to the seat base.

Advantageously, the base portion includes load bearing members for bearing reaction forces acting on the locking member as a result of forward or rearward pressure on the seat squab. Advantageously, the base portion includes a housing having at least one side wall, a front wall and a rear wall, said front and rear walls comprising said load bearing members. The housing may include at least one plate member having a substantially U-shaped cross-section. Preferably, a box-section housing is provided. The box section housing is very strong and inexpensive to manufacture.

Advantageously, the locking formations comprise a convex toothed segment provided on said pivot arm and a concave toothed segment provided on said locking member. This allows the mechanism to be locked in a plurality of reclined positions. Advantageously, the average segment tooth angle for the two sets of teeth lies in the range 50° to 75°, and is preferably approximately 60°. Preferably, at least one of said sets of teeth is asymmetrical.

Advantageously, the locking member comprises a substantially flat plate that is mounted for sliding movement relative to the base portion. The locking member may be mounted for sliding movement between two guide members. These guide members may be separate components mounted within the housing or they may comprise the front and rear walls of the housing.

Advantageously, the mechanism includes a compensating element that is constructed and arranged to reduce free play of the locking member in a direction perpendicular to the direction of said sliding movement. Preferably, the compensating element is wedge shaped and is mounted for sliding movement between the locking member and the base portion. Advantageously, the wedge-shaped guide members has front and rear walls that subtend an angle in the range 1°-5°, preferably 2°-4°, more preferably approximately 3°. The compensating element may be acted on by a biassing member. This mechanism adjusts automatically for wear and tear and prevents free play, judder and rattle.

Advantageously, the recliner mechanism includes a cam element for controlling movement of the locking member. This provides for simple adjustment of the position of the locking member.

The recliner mechanism may include a biassing element for biassing the locking member towards a locked position.

Advantageously, the recliner mechanism is constructed and arranged to allow the squab to be pivoted forwards to a tipped position (which may provide a tumble/flip and fold function).

The recliner mechanism may also include a latching mechanism for latching the pivot arm with the squab in a tipped position. The latching mechanism may include a latching element that engages the pivot arm. Preferably, the latching element is biassed to a latched condition. The latching mechanism is preferably constructed and arranged such that in the event of a frontal collision, the inertia of the mechanism tends to maintain a latched condition. The latching mechanism serves to lock the reclining mechanism in a tipped condition, preventing unintentional movement in that position and locking it against movement in the event of a collision.

The recliner mechanism may include a lock-out mechanism for preventing engagement of the locking mechanism when the seat squab is tipped forwards, thereby preventing mis-use of the mechanism.

Advantageously, the recliner mechanism includes abiassing element for biassing the squab forwards from a reclined position.

According to further aspect of the invention there is provided a recliner mechanism for a vehicle seat having a seat base and a reclining squab, the mechanism including a base portion and a pivot arm mounted on the base portion for movement relative thereto, and a latching mechanism for latching the pivot arm with the squab in a tipped position relative to the seat base, wherein said latching mechanism is constructed and arranged such that in the event of a frontal collision, the inertia of the mechanism tends to maintain a latched condition.

According to further aspect of the invention there is provided a recliner mechanism for a vehicle seat having a seat base and a reclining squab, the mechanism including a pivot arm, a base portion, a locking mechanism for locking the pivot arm relative to the base portion, and a lock-out mechanism for preventing engagement of the locking mechanism when the seat squab is tipped forwards.

In a preferred embodiment, the mechanism includes only a few moving parts, which are contained within two side walls that are formed as steel plates. The side walls comprise a basic U-shaped pressing and a flat plate, which are welded together into a box section. The front and back flanges of the U-shaped pressing form the front and rear walls of the box section. Manufacturing the side walls from pressings allows the spacing between the front and rear flanges to be closely controlled. Those flanges carry all the internal loads. The U-shaped pressing can be adapted to any specified seat application.

The mechanism preferably includes a fixed pivot. This allows pairs of mechanisms on the same seat to work together by remote control.

The mechanism allows for an integral seat tipping mechanism, allowing the squab to tip forwards about the same pivot axis as the recline function. This avoids the need for a second pivot axis for the tip function. Tipping the squab also allows the rear surface of the squab to be used for example as a picnic table.

The mechanism is highly adaptable, compact and self-contained and requires minimal intrusion into the occupant critical zone owing to the use of cranked locking parts and the low position of those parts. It provides light, easy operation even when under normal operational load, and accomplishes all recliner customer requirements without any reduction in comfort or safety.

The mechanism may be made of steel plate, pressed parts and turned or forged shafts and pins. It is therefore relatively inexpensive to construct and assemble. Other suitable materials may be used for some or all of the parts. To increase the strength of the pivot arm and the locking member, those parts may be double layered.

Embodiments of the present invention will now be described, by way of example, with reference to the accompanying drawings, in which:

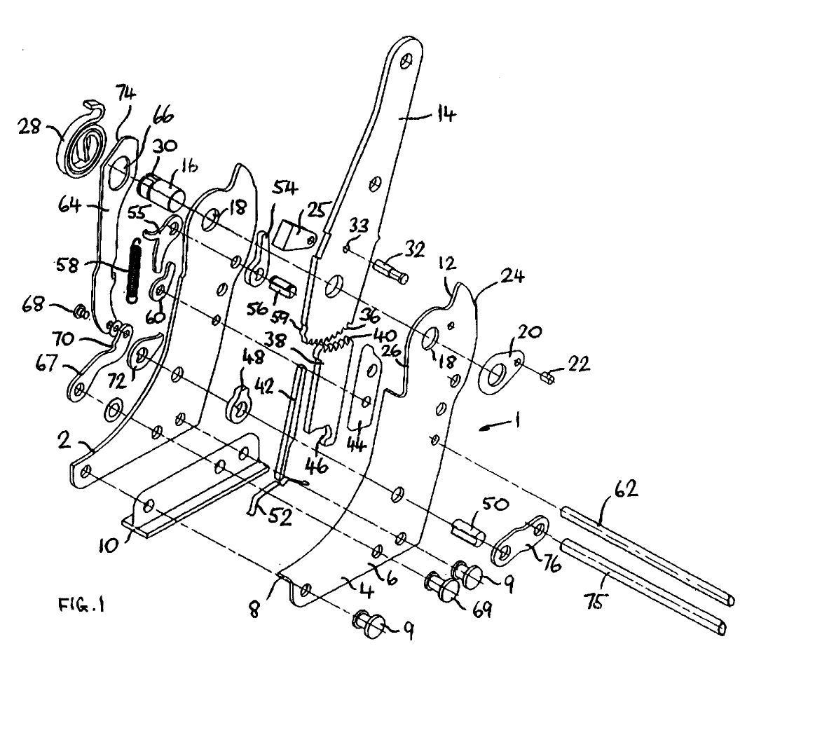

FIG. 1 is an exploded isometric view of a first recliner mechanism according to the invention;

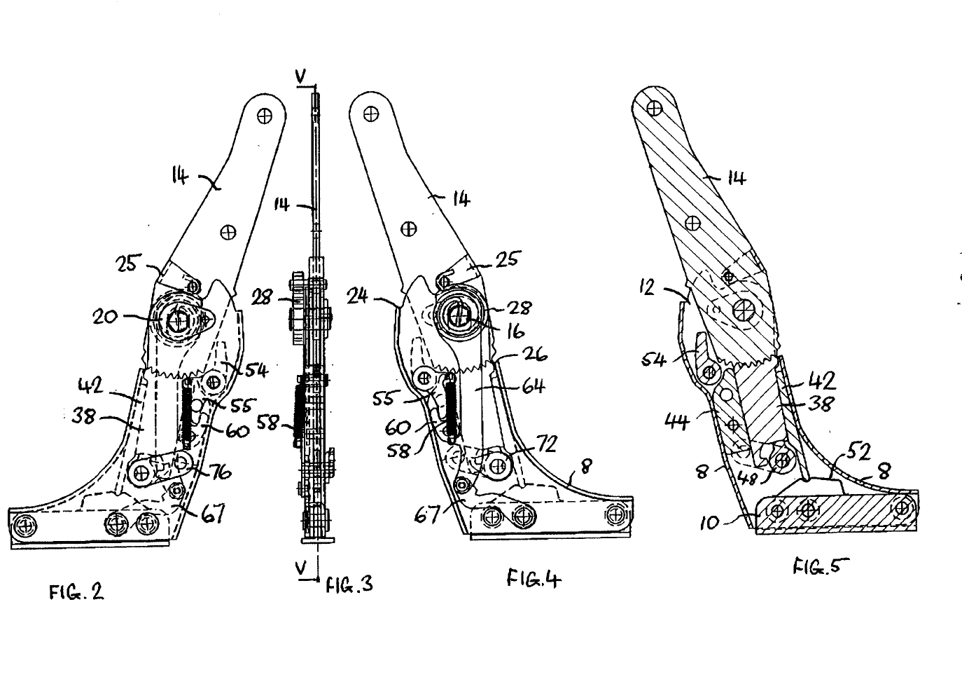

FIG. 2 is a left-hand side view;

FIG. 3 is a front view,

FIG. 4 is a right-hand side view;

FIG. 5 is a right-hand sectional view on line V-V of FIG. 3;

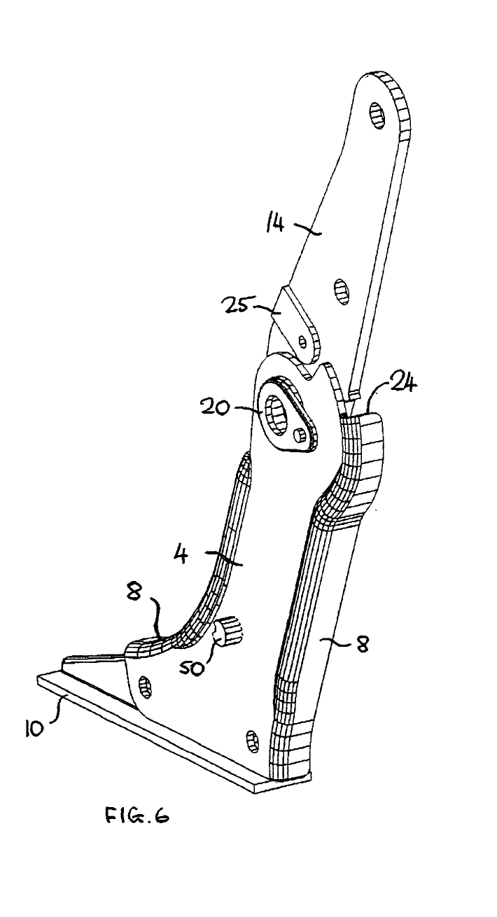

FIG. 6 is an isometric view from behind of a second recliner mechanism according to the invention;

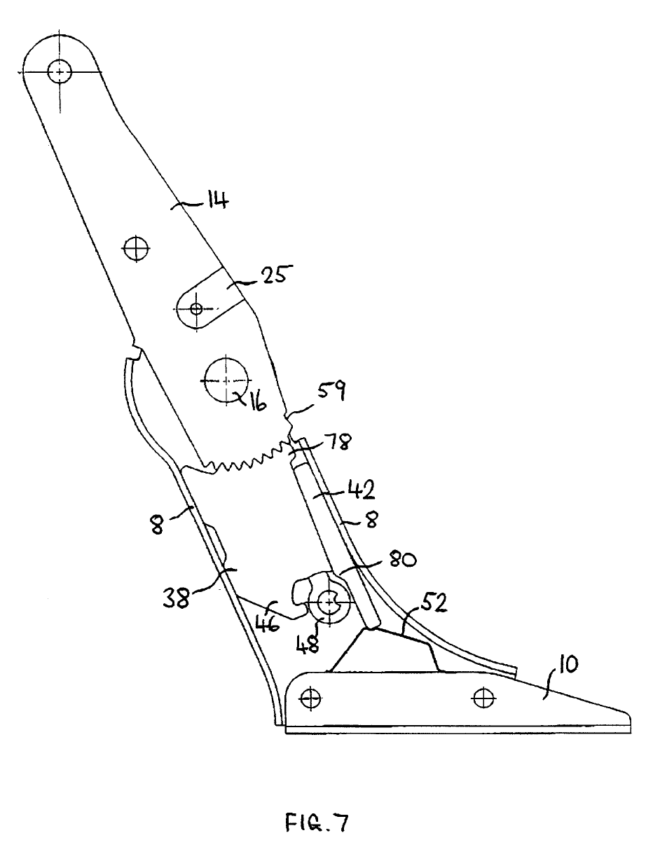

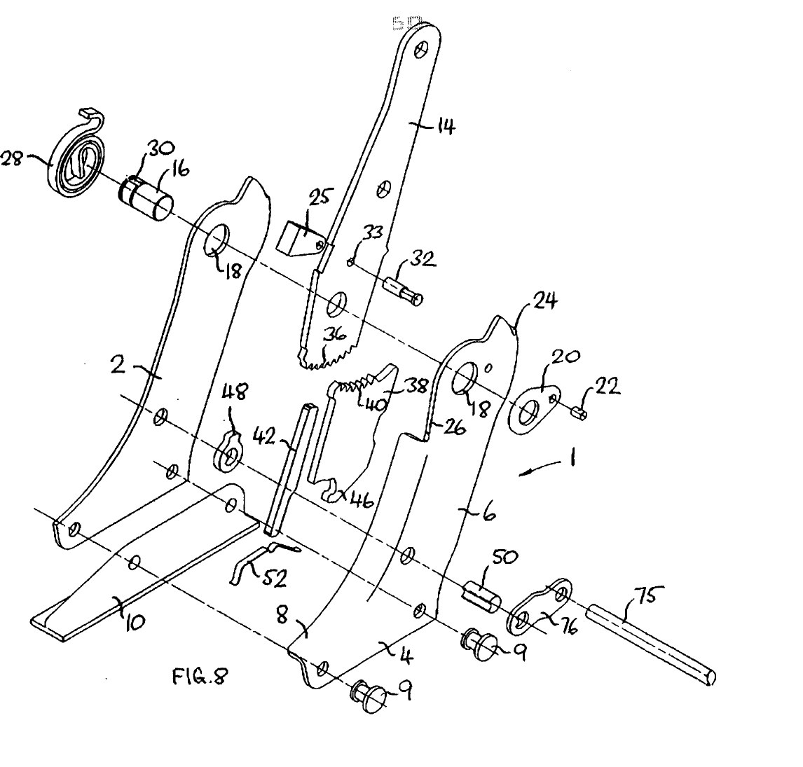

FIG. 7 is a sectional side view of the second recliner mechanism;

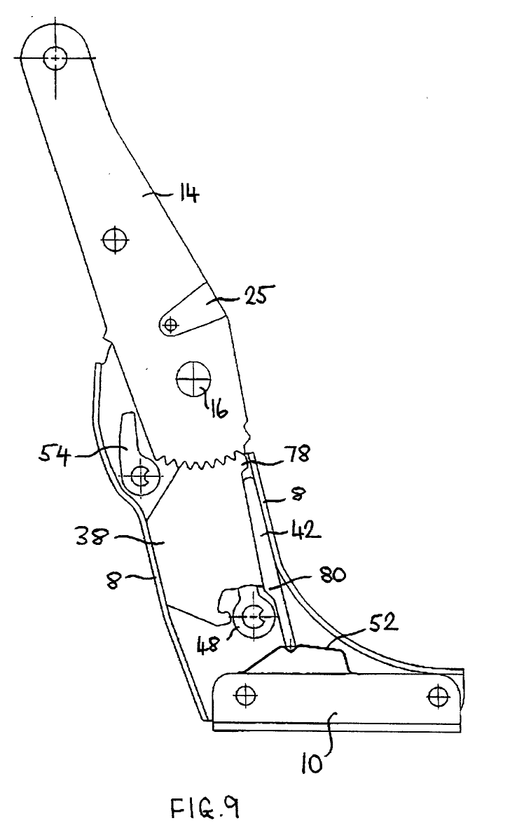

FIG. 8 is an exploded isometric view of the second recliner mechanism;

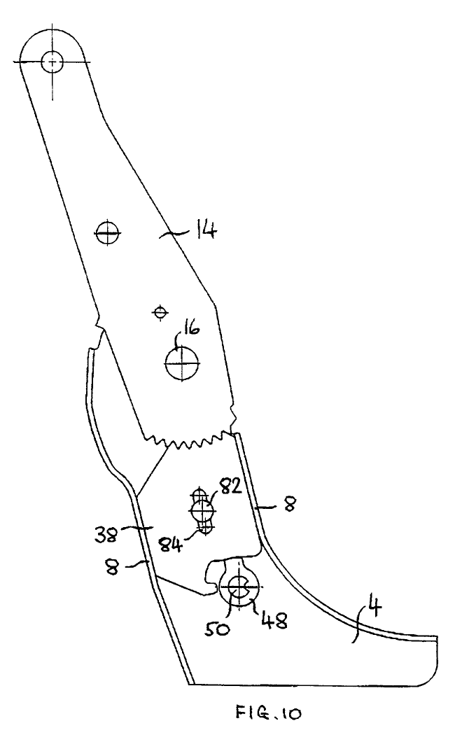

FIG. 9 is a sectional side view of a third recliner mechanism according to the invention;

FIG. 10 is a sectional side view of a fourth recliner mechanism according to the invention;

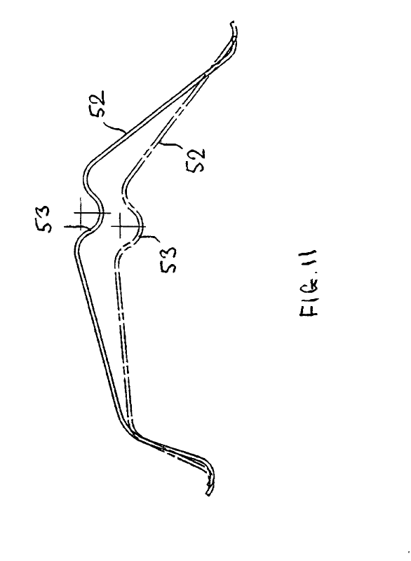

FIG. 11 is a side view of a leaf spring, showing the spring in an unstressed condition (in solid lines) and a stressed condition (in broken lines), and

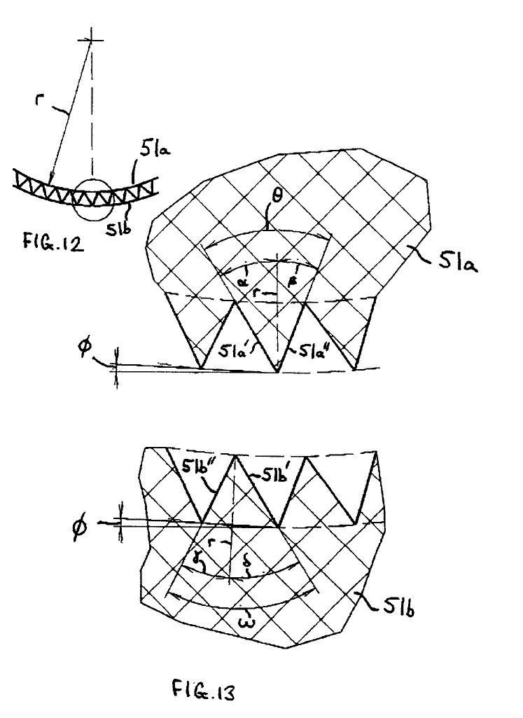

FIGS. 12 and 13 are side views at different scales of a pair of tooth formations.

A first recliner mechanism according to the invention is shown in FIGS. 1 to 5 of the drawings. Each reclining vehicle seat will normally include two such recliner mechanisms, which are interlinked and mounted on either side of the seat joining the reclining squab to the seat base, preferably at the extremities (the widest point) of the seat. Alternatively, the seat may include a recliner mechanism on just one side and a plain pivot on the opposite side. In practice, the mechanism will normally be covered, either by the upholstery of the seat or by a rigid cover.

The recliner mechanism includes a housing 1 formed from two steel plates, those being a flat closing plate 2 and a pressed plate 4 that has a shallow U-shaped cross-section, comprising a substantially flat side plate 6 and a peripheral wall 8 that extends towards the flat closing plate 2. The plates 2, 4 are welded together along the free edge of the peripheral wall 8, forming a very strong box-section.

The housing 1 is roughly boot-shaped and is secured at its lower end (the sole of the “boot”) by means of rivets 9 or other fasteners to a mounting member 10 that has a cross-section of an inverted T. This mounting member is attached in use to one of the seat slides (or the seat base) and the housing 1 is thus fixed relative to the seat base. The mounting member 10 may alternatively be omitted and the housing 1 attached direct to the slide or seat base. Towards the upper end of the housing (at the knee of the “boot”), a gap is provided in the peripheral wall 8 forming an opening 12 into the housing.

A pivot arm 14 made of steel plate, which in use is attached to and supports the seat back or squab, extends through the opening 12 and is mounted for pivoting movement on a pivot pin 16 that extends through the housing and is located in corresponding openings 18 in the side plates 2, 4. One end of the pivot pin 16 is welded or fixed to a pin head 20, which is secured to the pressed plate 4 by a reaction pin 22 to prevent rotation of the pivot pin. This mounting method avoids welding onto the side plate 4 and thus avoids compromising the material integrity of the pressed plate 4, ensuring maximum housing strength. It also allows the pivot pin 16 to be demounted.

Movement of the pivot arm 14 is limited by engagement of the arm with the edges of the peripheral wall 8. Thus, rearwards or reclining movement is limited by the arm engaging a first stop surface 24 on the rear portion of the peripheral wall, and forwards or tipping movement of the arm is limited by a U-shaped component 25 on the arm engaging a second stop surface 26 on the front portion of the peripheral wall. Alternatively, the arm may itself engage the stop surface.

A clock spring 28 is mounted on the second end of the pivot pin 16, which extends outwards beyond the housing 1. The inner end of the clock spring engages a slot 30 in the second end of the pivot pin 16 and the outer end of the spring is looped around a pin that extends through a hole 33 in the pivot arm 14 and is retained in position by the U-shaped component 25. This arrangement is preferred since welding the p into the arm would cause micro-fractures which could compromise the integrity and strength of the pivot arm. The spring 28 biasses the pivot arm forwards and thus assists with returning the seat squab to an upright position from a reclined position.

The pivot arm 14 may be locked in a number of different reclined positions by means of a locking mechanism. A first set of teeth forming a convex tooth segment 36 is provided at the lower end of the pivot arm 14. A locking member 38 comprising a metal plate having a second set of teeth forming a concave tooth segment 40 is located below the pivot arm and mounted for up and down sliding movement between front and rear glide blocks 42, 44. The locking member 38 is provided at its lower end with a cam follower formation 46, which is engaged by a rotatable cam element 48 mounted on a pivot pin 50. The cam element 48 is biassed to the “locked” position by a spring (not shown) through the pivot pin 50.

When the cam element 48 is in the position shown in FIG. 5, the concave tooth segment 40 on locking member 38 is locked in engagement with the convex tooth segment 36 provided at the lower end of pivot arm 14, thereby preventing movement of the arm. To release the locking element, the cam element 48 is rotated from that position anti clockwise through an angle of approximately 70°. This draws the locking member 38 downwards so that it disengages the pivot arm 14, which allows the seat squab to be rotated to a different reclined position.

The average segment tooth angle for the two sets of teeth preferably less in the range 50° to 75°, and is preferably approximately 60°. If the angle is less than 50° the teeth may be too weak to withstand the stresses placed upon them, particularly in the event of a collision, whereas if the angle is greater than 75° the forces tending to push the sets of teeth when the mechanism is loaded apart may be too large to be contained by the housing.

The teeth may also have an asymmetric or saw tooth formation, with a lower tooth angle for the faces that bear the forces when the seat squab is forced forwards and a higher tooth angle for the other faces. This will allow the teeth to transfer very large forces without being forced apart in the event of a frontal collision, while still having sufficient strength to withstand the lower rearward forces encountered during normal use of the mechanism, or in the event of a rearward crash.

In the example shown in FIGS. 12 and 13, the average segment tooth angle is 60° and the arc Φ between adjacent teeth is 7.5°. On the convex upper set of teeth 51a, the angle θ between the two faces of each tooth is therefore 52.5° (60°−Φ). The faces 51a′ of the teeth that bear rearward forces are set at an angle α of 31° relative to the radias r of the tooth segment, whereas the faces 51a″ of the teeth that bear forward forces are set at an angle β of 21.5°. On the concave lower set of teeth 51b, the angle Ω between the two faces of each tooth is 67.5° (60°+Φ). The faces 51b′ of the teeth that bear rearward forces are set at an angle δ of 38.5° relative to the radius r and the faces 51b″ of the teeth that bear forward forces are set at an angle γ of 29°. In this example, the mechanism is capable of withstanding a forward load of 4000 Nm in the event of a frontal crash and a rearward force of 2400 Nm in tic event of a rear end crash.

Movement of the locking member 38 is guided by the two glide blocks 42, 44, which are positioned in front of and behind the locking member 38, between the front and rear portions of the peripheral wall 8. The inner faces of the glide blocks are parallel, allowing the locking member 38 to slide between them. However, the front and rear portions of the peripheral wall 8 converge towards each other, and the front glide block 42 is wedge-shaped and is biassed upwards by a leaf spring 52 that sits on the upper edge of the mounting member 10. This ensures that there is no fore-and-aft free play in the mechanism. The mechanism thus compensates automatically for wear and tear and prevents judder and rattle.

The leaf spring 52, which shown in more detail in FIG. 11, includes two legs and a central depression 53 that receives the lower end of the glide block 42 and locates the spring in position. The spring is self-positioning and does not need to be captured or fixed. The legs of the spring 52 slide along a reference surface as the spring is stressed,

The pivot arm may also be rotated to raids from the upright position through an angle of approximately 100°, allowing the seat squab to be tipped forwards to a horizontal position. This allows the back of the seat squab to be used, for example as a picnic table. It should be noted that the tooth segments 36, 40 are relatively short, to ensure that none of the teeth are exposed when the squab is in an upright or reclined position, this being important for passenger safety.

When the seat squab is tipped forwards, the Tooth segments 36, 40 can no longer be brought into engagement to lock the squab in that position. A separate lathing mechanism is therefore provided, comprising a latching element 54 and a drop arm 55, which are mounted for rotation together on a short keyed pin 56 in the upper rear part of the housing 1. This mechanism is biassed forwards (clockwise in FIG. 5) by a spring 58, so that the latching element 54 engages a profile 59 on the front edge of the arm 14 when the squab is in a tipped position. The latching element 54 acts as a stop, allowing the squab to be tipped forwards but preventing it being returned to an upright position until the mechanism is disengaged. Furthermore, to prevent the mechanism disengaging in the event of a frontal impact, the latching element 54 is made from much thicker steel than the drop arm 55, with the result that it is heavier and has more inertia. This is important for safety and prevents the tipped squab from moving in the event of an accident.

To release the latching mechanism, a release arm 60 is provided, which is mounted on a rotatable release bar 62. Rotating the bar 62 causes the arm 60 to engage the drop arm 55, rotating it and the lathing element against the bias of the spring 58 and disengaging the latching element 54 from the profile 59. The seat squab may then be returned to an upright or reclined position.

As a fail-safe device and to prevent misuse, the recliner mechanism includes a “lock out” mechanism to prevent the locking member 38 moving upwards to the “locked” position while the squab is tipped forwards. This mechanism includes a push rod 64 having an elongated aperture 66 at its upper end, which is located around the free end of the pivot pin 16, and a lock open hook 67 having one end that is attached by a pivot pin 68 to the lower end of the push rod 64 and another end that is attached through a pivot 69 to the closing plate 2. A hook formation 70 is provided on one edge of the lock open hook 67. The push rod is biassed upwards by the spring 58 that is also attached to the drop arm 55. The mechanism also includes a lock open latch 72, which is connected to the cam element 48 via the pivot pin 50.

The upper end of the push rod 64 is provided with a cam surface 74 that is engageable by the pin 32 on the pivot arm 14. When the squab is in an upright or reclined position, the pin 32 engages the cam surface 74 and holds the push rod down, against the bias of the spring 58. However, then the squab is tipped forwards, the pin 32 slides off the front of the cam surface 74 and the push rod 64 is lifted upwards by the spring 58. This lifts the lock open hook 67 and the hook formation 70 engages the lock open latch 72, preventing the cam element 48 from rotating. The locking element 38 cannot then be lifted into the “locked” position.

When the seat squab is returned to an upright position, the pin 32 re-engages the cam surface 74, driving the push rod 64 downwards and disengaging the lock open book 67 from the lock open latch 72. The locking element 38 will then be lifted automatically into the “locked” position by rotation of the spring-biassed cam element 48.

To afford greater passenger comfort and to reduce the risk of serious injury in the event of an accident, it is important that the steel structure directly behind the occupant's spinal area should be as far away as possible. The recliner mechanism operating rod 75 is therefore attached to the pivot pin 50 for the cam element 48 through a crank 76, which removes it from the danger zone without it needing to be bent or joggled.

While the preceding paragraphs describe the function of the lock out mechanism, it should be understood that the mechanism may be packaged into a simpler and more compact modular type unit.

Various modifications of the mechanism shown in FIGS. 1 to 5 are possible, some of which will now be described.

The rear glide block 44 may be welded or rivetted to one or both of the side plates 2, 4 to maintain it in position. Alternatively, the rear glide block 44 may be replaced by two or more shouldered rivets, which act as guide members for the locking member 38, or by one or more formations that are formed in one or both of the side plates 2 and 4, for example by semi-shearing or fine blanking. The positions of the front and rear glide blocks 42, 44 may be reversed, so that the wedge shaped glide block 42 is located behind the locking member 38.

Instead of a flat closing plate 2 and a U-shaped plate 4, the housing 1 may consist of two U-shaped plates that are joined together around their periphery, or two flat plates that are held together by rivets, which also serve to retain the rear glide block 44 and guide the front glide block 42. Alternatively, the mechanism may be mounted on a single plate, the sliding components being held onto the plate by one or more pan head rivets that overlap the free edges of those components or extend through a slot in the plate.

The cam element 48 may be located to one side or at one end of the locking member 38 or within an aperture formed in the locking member, or it may be replaced by an alternative actuating mechanism, for example a rack and pinion. It can be of different size and design. The contact surface between the cam and the locking member 38 is preferably self-locking, although a spiral curve may also be used.

If the lock-out mechanism is not required, it may be omitted without affecting operation of the other parts of the recliner mechanism.

A second recliner mechanism according to the invention is shown in FIGS. 6, 7 and 8 of the drawings. Except as described below, the second mechanism is similar to the first mechanism shown in FIGS. 1 to 5 and corresponding reference numbers have been used where appropriate.

In the second recliner mechanism, the rear glide block is omitted and the locking member 38 is extended backwards, to engage the rear portion of the peripheral wall 8. Movement of the locking member 38 is therefore guided between the wedge-shaped front glide block 42 and the rear portion of the peripheral wall 8. The latching mechanism comprising the latching element 54 and the drop arm 55, and the lock out mechanism 64-72, have also been omitted. This is a simpler recliner mechanism that requires fewer parts, but which may be satisfactory in certain situations.

A third recliner mechanism according to the invention is shown in FIG. 9. This mechanism is similar to the second mechanism except that it includes a latching element 54 for latching the mechanism with the squab tipped forwards. The drawing illustrates two features that are also found in the first and second recliner mechanisms, but are not described in detail above. First, the locking member 38 has a protruding nose 78 at the upper end of its front edge, which engages and releases the wedge 42 as the locking member slides downwards,-preventing it from sticking in position. Second, at the lower end of the wedge 42 a step 80 is provided, which engages the cam element 48 to limit downwards movement of the wedge in the event of breakage of the leaf spring 52, thereby providing for fail safe operation.

A fourth recliner mechanisms according to the invention is shown in FIG. 10. In this embodiment of the invention, which is simplest version described here, the wedge-shaped front glide block 42 has been omitted, and the locking member 38 has been extended forwards to engage the front portion of the peripheral wall 8. Movement of the locking member 38 is guided between the front and rear portions of the peripheral wall 8, which are parallel with one another. The mechanism does not compensate for wear of the locking member and the peripheral wall, it is satisfactory for certain less demanding applications. The flat closing plate has also been omitted, the locking member being attached to the U-shaped plate 4 by means of a pan head rivet 82 that extends through a slot 84 in the guide member 38.

In each of the mechanisms shown in the accompanying drawings, the locking member 38 is located in the housing 1 that is attached to the seat base and the pivot arm 14 is attached to the squab. It should however be understood that the mechanism may be inverted, so that the pivot arm 14 is attached to the seat base and the housing 1 is attached to the squab. The pivot arm 14 will then remain stationary whilst the housing 1, the locking member 38, the glide blocks 42, 44, the cam element 48, the latching mechanism and the lock-out mechanism rotate with the squab about the axis of the pivot pin 16. This arrangement may be preferred when, for example, a control handle for operating the cam element 48 is to be located at the top of the squab rather than on the scat base.

The loading forces acting on the mechanism are generally higher in the event of a frontal collision than a rear collision. Accordingly, the mechanism needs more strength to withstand frontal collision forces than for rear collision forces. This uneven strength requirement can be provided by offsetting the pivot pin 16 rearwards from the centre of the radius of the teeth. This will ensure optimal engagement of the teeth in the event of a frontal collision, as the mechanism compresses under the collision loads.

1. A pivot mechanism, the mechanism including a pivot arm, a base portion and a locking member mounted on the base portion for movement relative thereto, said locking member and said pivot arm having mutually engageable locking formations, the mechanism being constructed and arranged such that when the locking formations are engaged, movement of the pivot arm relative to the base portion is prevented.

2. A mechanism according to claim 1, wherein the base portion includes load bearing members for bearing reaction forces acting on the locking member as a result of forward or rearward pressure on the pivot arm.

3. A mechanism according to claim 2, wherein the base portion, includes a housing having at least one side wall, a front wall and a rear wall, said front and rear walls comprising said load bearing members.

4. A mechanism according to claim 3, wherein the housing includes at least one plate member having a substantially U-shaped cross-section.

5. A mechanism according to claim 3, wherein He housing has a box-section construction.

6. A mechanism according to claim 1, wherein the locking formations comprise a convex toothed segment provided on said pivot arm and a concave toothed segment provided on said locking member.

7. A mechanism according to claim 6, wherein the average segment tooth angle for the two sets of teeth lies in the range 50° to 75°, and is preferably approximately 60°.

8. A mechanism according to claim, 6, wherein at least one of said sets of teeth is asymmetrical.

9. A mechanism according to claim 1, wherein said locking member is mounted for sliding movement relative to the base portion.

10. A mechanism according to claim 9, including a compensating element that is constructed and arranged to reduce free play of the locking member in a direction perpendicular to the direction of said sliding movement.

11. A mechanism according to claim 10, wherein said compensating element is wedge shaped and is mounted for sliding movement between the locking member and the base portion.

12. A mechanism according to claim 11, wherein the compensating element has front and rear walls that subtend an angle in the range 1°-5° preferably 2°-4°, more preferably approximately 3°.

13. A mechanism according to claim 10, wherein the compensating element is acted on by a biassing member.

14. A mechanism according to claim 1, including an element for controlling movement of the locking member.

15. A mechanism according to claim 1, including a biassing element for biassing the locking member towards a locked position.

16. A mechanism according to claim 1, the mechanism being constructed and arranged to allow the pivot arm to be pivoted forwards to a tipped position.

17. A mechanism according to claim 16, including a latching mechanism for latching the pivot arm in a tipped position.

18. A mechanism according to claim 17, wherein said latching mechanism includes a latching element that engages the pivot arm.

19. A mechanism according to claim 18, wherein said latching element is biassed to a latched condition.

20. A mechanism according to claim 17, wherein said latching mechanism is constructed and arranged such that in the event of a frontal impact, the inertia of the mechanism tends to maintain a latched condition.

21. A mechanism according to claim 16, including a lock-out mechanism for preventing engagement of the locking mechanism when the pivot arm is tipped forwards.

22. A mechanism according to claim 1, including a biassing element for biassing the pivot arm forwards from a reclined position.

23. A recliner mechanism for a vehicle seat having a seat base and a reclining squab, said recliner mechanism including a pivot mechanism according to claim 1.

24. A recliner mechanism for a vehicle seat having a seat base and a reclining squab, the mechanism including a base portion and a pivot arm mounted on the base portion for movement relative thereto, and a latching mechanism for latching the pivot arm with the squab in a tipped position relative to the seat base, wherein said latching mechanism is constructed and arranged such that in the event of a frontal collision, the inertia of the mechanism tends to maintain a latched condition.

25. A recliner mechanism for a vehicle seat having a seat base and a reclining squab, the mechanism including a pivot arm, a base portion, a locking mechanism for locking the pivot arm relative to the base portion, and a lock-out mechanism for preventing engagement of the locking mechanism when the seat squab is tipped forwards.
